(19) United States
(12) Patent Application Publication
(10) Pub. No.: US 2026/0167300 A1
(43) Pub. Date: Jun. 18, 2026

(54) Method for Operating a Gearshift for a Pedal-Driven Vehicle, Gearshift, and Pedal-Driven Vehicle with Gearshift

(71) Applicant: Robert Bosch GmbH, Stuttgart (DE)

(72) Inventors: Daniel Gronbach, Stuttgart (DE); Joseph Reck, Weil Im Schoenbuch (DE); Juergen Stegmaier, Wannweil (DE); Marcus Boege, Rottenburg Am Neckar (DE); Matthias Weinmann, Balingen (DE)

(21) Appl. No.: 19/418,958

(22) Filed: Dec. 13, 2025

(30) Foreign Application Priority Data
Dec. 17, 2024 (DE) 10 2024 212 041.3

(51) Int. Cl. B62M 25/08

(52) U.S. Cl. CPC B62M 25/08

(57) ABSTRACT

A method is disclosed for operating a gearshift for a pedal-driven vehicle that includes a control unit and at least one user interface for manually triggering a shift operation. The method includes (i) receiving a first shift instruction including an indication of origin, in particular by the control unit, (ii) receiving a second shift instruction including an indication of origin, in particular by the control unit, wherein the indication of origin of the first shift instruction is different from the indication of origin of the second shift instruction, and (iii) adjusting the operation of the gearshift as a function of the first and/or the second shift instruction.

This application claims priority under 35 U.S.C. § 119 to patent application no. DE 10 2024 212 041.3, filed on Dec. 17, 2024 in Germany, the disclosure of which is incorporated herein by reference in its entirety.

### BACKGROUND

Pedal-driven vehicles may be equipped with automatic or semi-automatic gearshifts, respectively. Thus, in an automatic operation of the gearshift, shift operations may be triggered as a function of one or more travel parameters of the pedal-driven vehicle, such as a rider pedaling frequency and/or a speed of the pedal-driven vehicle.

Gearshifts may further include one or more user interfaces through which a rider of the pedal-driven vehicle may manually trigger shift operations, regardless of the automatic operation. Particularly by manually triggering shift operations during simultaneous automatic operation of the gearshift, conflicts may arise between different shift instructions and/or result in a disadvantageous shift behavior with respect to ride comfort.

### SUMMARY

The present disclosure relates to a method for operating a pedal-driven vehicle, a pedal-driven vehicle, a computer program product, a computer-readable medium, and a data carrier signal. Further features and details of the disclosure will emerge from the description and the drawings. Features and details described in connection with the method according to the disclosure naturally also apply in connection with the pedal-driven vehicle according to the disclosure and/or in connection with the computer program product according to the disclosure and/or in connection with the computer-readable storage medium according to the disclosure and/or in connection with the data carrier signal according to the disclosure, and vice versa, so that there is or can always be mutual reference with regard to the disclosure of the individual aspects of the disclosure.

The disclosure presented is particularly intended to provide improved operation of an, in particular automatic or semi-automatic, gearshift of a pedal-driven vehicle with respect to improved comfort of use and/or increased safety of the pedal-driven vehicle.

According to a first aspect, the present disclosure relates to a method for operating a gearshift for a pedal-driven vehicle, comprising a control unit and at least one user interface for manually triggering a shift operation:
receiving a first shift instruction comprising an indication of origin, particularly by the control unit,
receiving a second shift instruction comprising an indication of origin, in particular by the control unit, wherein the indication of origin of the first shift instruction is different from the indication of origin of the second shift instruction,
adjusting the operation of the gearshift as a function of the first and/or second shift instruction.

It may preferably be provided that the stated method steps are carried out in the specified order. Additionally or alternatively, it is contemplated that at least individual method steps will be performed recurrently, in particular in a loop and/or, at least in part, simultaneously. Additionally or alternatively, the method can be configured as a computer-implemented method.

In other words, a method for operating a gearshift for a pedal-driven vehicle, in particular a bicycle or electric cycle, preferably pedelec, is proposed. The gearshift includes at least one control unit and at least one user interface for triggering a manual shift operation.

In particular, the gearshift may be an automatic or at least semi-automatic gearshift, which is preferably configured to trigger shift operations (i.e., upshifts or downshifts) as a function of at least one travel parameter of the pedal-driven vehicle. Preferably, a travel parameter may be a speed of the pedal-driven vehicle and/or a pedaling frequency of a rider of the pedal-driven vehicle. In particular, despite the automatic or semi-automatic operation, it is provided that a rider can manually trigger shift operations via at least one user interface in addition to or as an alternative to the automatic or semi-automatic operation.

According to the present disclosure, it is provided that a first shift instruction, in particular by the control unit, is received, wherein the first shift instruction comprises an indication of origin.

In the present case, an indication of origin is to be understood as an indication of who or what the shift instruction is attributable to. Thus, the indication of origin may be characteristic of an automatically triggered shift operation or characteristic of a manually triggered shift operation, in particular by a rider of the pedal-driven vehicle.

If, for example, a certain speed is exceeded by the pedal-driven vehicle, a shift instruction for the change to a higher gear can be generated and transmitted to the control unit in an automatic operation of the gearshift. Alternatively, the shift instruction may also be generated or provided directly in the control unit. In that case, the shift instruction would comprise an indication of origin, which is characteristic of an automatically triggered shift operation. If, on the other hand, a user interface is actuated to manually trigger a gear change by a user, a corresponding shift instruction is also generated and transmitted to the control unit, but the shift instruction includes an indication of origin that is characteristic of a manually triggered shift operation.

Furthermore, it is provided that a second shift instruction, in particular by the control unit, is received, wherein the second shift instruction also comprises an indication of origin. With respect to the present disclosure, it is provided that the indication of the origin of the first shift instruction is different from the indication of the origin of the second shift instruction. In other words, the indication of origin of one of the shift instructions is characteristic of an automatically triggered shift operation and the indication of origin of the other shift instruction is characteristic of a manually triggered shift operation.

According to the disclosure, the operation of the gearshift is adjusted as a function of the first and/or second shift instruction. The adjustment may preferably comprise discarding and/or prioritizing and/or implementing at least one shift instruction.

In the context of the present disclosure, it has been found that in particular shift instructions of different origins can often lead to conflicts or disadvantageous operating behavior of the gearshift. For example, automatically and manually triggered shift operations may add up, thus leading to undesirable changes in the transmission ratio. Alternatively, manually and automatically triggered shift operations may contradict, which may result in unfavorable as well as sometimes unnecessary or undesirable shifts. The proposed method allows for a need-based adjustment of the operation of the gearshift for shift instructions of different origins.

It may in particular be provided that the first shift instruction and the second shift instruction are received chronologically in succession and/or that no further shift instructions are received between the first shift instruction and the second shift instruction. In particular, the first shift instruction may be received chronologically prior to the second shift instruction. In other words, it may be provided that the described method refers to two shift instructions received immediately in succession.

It may preferably be provided that the method further comprises implementing at least one, in particular first or second or third, shift instruction. To implement a shift instruction, further components of the gearshift, such as a derailleur or the like, in particular by the control unit, may be controlled accordingly to perform a shift corresponding to the shift instruction. Additionally or alternatively, an implementation of a shift instruction may include that the shift instruction is placed in a waiting list of shift instructions, or if the waiting list is empty, is immediately implemented.

Additionally or alternatively, it is contemplated that the second shift instruction was received within a predetermined time interval after receipt of the first shift instruction. In other words, it may be provided that the respective method steps are performed only when shift instructions have been received within a predetermined time interval, in particular by the control unit. This ensures that only conflicts between briefly successively generated or received shift instructions are resolved and time-spaced shift instructions are executed in their order.

With respect to the present disclosure, it may preferably be provided that the first shift instruction comprises a target gear indication and the second shift instruction comprises a target gear indication, wherein adjusting the operation of the gearshift comprises:
discarding the second shift instruction when the target gear indication of the second shift instruction matches the target gear indication of the first shift instruction, and optionally,
implementing the first shift instruction.

In the present case, a target gear specification is to be understood as an indication of the gear that is to be engaged when the shift instruction is implemented. A target gear information may preferably be represented by the specific, in particular numerical, specification of a specific gear. Alternatively, a target gear specification can also be represented by an actual gear information, i.e. a specification of the currently engaged gear, as well as a shift direction specification, i.e. a specification of whether an upshift or downshift is to be performed.

By integrating a target gear specification into the shift instructions, shift instructions can be identified that have an identical target state of the gearshift as their subject. In this case, the implementation of one of the shift instructions is sufficient, wherein the other shift instruction can be discarded. Accordingly, only one shift instruction is implemented and it is ensured that shifts are not beyond the target gear specification.

With respect to the present disclosure, it may be advantageously provided that adjusting the operation of the gearshift comprises:
discarding the second shift instruction when the second shift instruction has been received within a predetermined time interval from receipt of the first shift instruction, particularly if the indication of the origin of the second shift instruction is characteristic of an automatically triggered shift operation, and optionally,
implementing the first shift instruction.

In other words, it may be provided that the second shift instruction is ignored if it has been received within a predetermined time interval from receipt of the first shift instruction. For example, the time interval may be between 0.1 s and 1 s, in particular between 0.1 s and 0.5 s.

Such a procedure has shown to be particularly advantageous, if the indication of the origin of the first shift instruction is characteristic for a manually triggered shift operation and the indication of origin of the second shift instruction is characteristic of an automatically triggered shift operation and/or if the first and second shift instructions have different shift direction, for example the first shift instruction is an upshift and the second gearshift is a downshift. This allows the rider's intention to be prioritized and enables an intuitive and comfortable operational behavior of the gearshift for the rider.

It is further contemplated in the context of the present disclosure that an implementation status of the first shift instruction is detected, wherein the implementation status is characteristic of whether the first shift instruction has been implemented, and wherein adjusting the operation of the gearshift comprises:
discarding the first shift instruction when the implementation status is negative, in particular by the control unit, and optionally
implementing the second shift instruction.

In other words, the first shift instruction is replaced with the second shift instruction, provided the first shift instruction has not yet been implemented. This method has proven particularly advantageous if the indication of origin of the second shift instruction is characteristic of a manually triggered shift operation and/or if the first and the second shift instructions have different shift directions.

In particular, it can be provided that the first shift instruction is discarded only if the indication of origin of the second shift instruction is characteristic of a manually triggered shift operation. This allows the rider's intention to be prioritized.

A time-delayed execution of shift instructions and a correspondingly negative implementation status can occur, for example, during a synchronization of shift operations with dead points of the rider torque and/or the execution of several briefly successive shift operations.

An implementation status should in the present case be understood as an indication of whether the respective shift instruction has already been implemented or not. In the context of the present disclosure, a positive implementation status is to be characteristic of the fact that implementation has already taken place and a negative implementation status is to be characteristic of the fact that no implementation has yet occurred. In the present case, it can be sufficient for an implementation or a positive implementation status that a shift operation corresponding to the shift instruction has been initiated, i.e. a converter for moving the chain, in particular by the control unit, has been activated or moved. The actual completion of the shift operation may be time-delayed to initiate the shift operation.

Additionally or alternatively, it may be contemplated that an implementation status of the first shift instruction is further detected, wherein the implementation status is characteristic of whether the first shift instruction has already been implemented, and wherein adjusting the operation of the gearshift comprises:
providing a third shift instruction, wherein the third shift instruction is inversely configured to the first shift instruction if the implementation status is positive and/or the indication of origin of the second shift instruction is characteristic of a manually triggered shift operation, in particular by the control unit, and optionally
discarding the second shift instruction and/or implementing the third shift instruction.

In other words, it may preferably be provided that, in particular if the first shift instruction has already been implemented, a third shift instruction is provided, in particular independently of the second shift instruction, which is inversely configured to the first shift instruction. This means that when the third shift instruction is executed, the first shift instruction is inverted, i.e. reversed. This has proven particularly intuitive for a rider, who in this case may need to manually trigger a shift operation again, but is not confronted with uncontrolled shift operations or numerous short-term gear changes.

Preferably, with respect to the present disclosure, it may be provided that adjusting the operation of the gearshift comprises:

blocking receipt of further shift instructions for a predetermined time period from receipt of the second shift instruction, in particular by the control unit.

Controlled processing of the shift instructions can thereby be realized.

In particular, with respect to the present disclosure, it may be provided that adjusting the operation of the gearshift comprises:
blocking a reception or generation of further shift instructions with an indication of origin characteristic of an automatically triggered shift operation, for a predetermined time interval from receipt of a shift instruction, the indication of origin of which is characteristic of an automatically triggered shift operation, and/or
In other words, upon receipt of a shift instruction with an indication of origin characteristic of a manually triggered shift operation, the receipt or generation of further shift instructions with an indication of origin characteristic of an automatically triggered shift operation is blocked for a predetermined time period. An automated operation of the gearshift is thus suspended. This ensures that automatic operation of the gearshift does not interfere with a rider's manual shift instructions.

It may further be provided in relation to the present disclosure that at least one travel parameter or a rate of change over time of at least one travel parameter is detected, in particular by a detection unit, wherein adjusting the operation of the gearshift comprises:
blocking a reception or generation of further shift instructions with an indication of origin characteristic of an automatically triggered shift operation from receipt of a shift instruction, the indication of origin of which is characteristic of an automatically triggered shift operation, until a rate of change over time of at least one travel parameter reaches or falls below a predetermined limit value.

In other words, upon receipt of a shift instruction with an indication of origin characteristic of a manually triggered shift operation, the receipt or generation of further shift instructions with an indication of origin characteristic of an automatically triggered shift operation is blocked. An automated operation of the gearshift is thus suspended. Blocking continues until a rate of change over time, in particular the amount of the rate of change over time, at least one travel parameter reaches or falls below a predetermined limit value.

This may result in the advantage that automatic operation of the gearshift is suspended in dynamic driving situations in which the rider performs manual shift operations and only becomes active again when a stationary or quasi-stationary travel state is achieved again. In the present case, a rate of change over time is to be understood as a change of the relevant travel parameter per unit of time.

A travel parameter may in particular be a speed of the pedal-driven vehicle and/or a rider pedaling frequency, in particular at a crank mechanism of the pedal-driven vehicle, and/or a rider torque, in particular introduced via a crank mechanism of the pedal-driven vehicle, and/or a rider power, in particular introduced via a crank mechanism of the pedal-driven vehicle.

According to a second aspect, the present disclosure relates to a gearshift for a pedal-driven vehicle comprising at least one control unit and at least one user interface for manually triggering a shift operation. Preferably, the gearshift is configured to be operated according to a method according to the disclosure, in particular a method according to the first aspect of the disclosure. With respect to a gearshift, the same advantages result as described in relation to a method according to the disclosure.

In particular, the gear shift may be provided to provide a variable transmission ratio, in particular in a drive train of the pedal-driven vehicle. The transmission ratio may be in particular characteristic of the number of revolutions of a drive wheel of the pedal-driven vehicle per revolution of a crank mechanism of the pedal-driven vehicle. In this respect, a high transmission ratio or high gear characterizes a comparatively high number of revolutions of the drive wheel per revolution of the crank mechanism. In contrast, a low transmission ratio or low gear characterizes a comparatively low number of revolutions of the drive wheel per revolution of the crank mechanism. In particular, a rider of the pedal-driven vehicle may introduce a rider torque or a rider power to propel the vehicle, in particular via crank-drive pedals, via the crank mechanism.

In the present case, the gear shift may be configured as a derailleur gear system or a hub gear. Additionally or alternatively, it may be provided that the gear shift is configured as an automatic or at least partially automated gear shift. Particularly preferably, the gearshift may be configured to initiate or perform automated shift operations based on one or more travel parameters, in particular as a function of the rider pedaling frequency and/or speed of the pedal-driven vehicle. The gearshift may preferably comprise at least one user interface, in particular a shift lever, via which a rider can manually trigger shift operations. In particular, a user interface for upshifting and a user interface for downshifting may be provided.

Preferably, at least one user interface of the gearshift may be configured as an electromechanical user interface, i.e., an interface that converts mechanical actuation, in particular by a rider of the pedal-driven vehicle, into an electrical signal. For example, the user interface may be configured as a shift lever that actuates a switch when actuated.

Preferably, the gearshift may comprise at least one detection unit. In particular, at least one detection unit may comprise at least one sensor or at least one sensor element for detecting a travel parameter of the pedal-driven vehicle. A rate of change over time of a travel parameter can in particular be determined by time differentiation of the sensor signal determined from the travel parameter, in particular time-discrete.

In particular, at least one detection unit may comprise at least one speed sensor for detecting a speed of the pedal-driven vehicle. For example, at least one speed sensor may be configured to measure a speed of the pedal-driven vehicle, for example, via the rotational speed of a wheel of the pedal-driven vehicle and the outer circumference of the wheel.

Additionally or alternatively, at least one detection unit may comprise a rotational speed sensor for detecting a rider pedaling frequency, in particular at a crank mechanism of the pedal-driven vehicle.

Preferably, at least one detection unit may further comprise a torque sensor for detecting a rider torque, particularly at a crank mechanism of the pedal-driven vehicle. Preferably, a rider power may be determined as a product of the rider torque and the rider pedaling frequency.

According to a third aspect, the present disclosure relates to a pedal-driven vehicle comprising at least one gearshift according to the second aspect of the present disclosure. The pedal-driven vehicle is preferably configured to be operated according to a method according to the disclosure, in particular according to a method according to the first aspect of the disclosure. Preferably, the pedal-driven vehicle may be configured as a bicycle, preferably an electric cycle or pedelec. With respect to a pedal-driven vehicle, the same advantages result as described in relation to a method according to the disclosure and/or a gearshift according to the disclosure. Preferably, the pedal-driven vehicle may comprise two wheels, in particular a front wheel and a rear wheel.

The pedal-driven vehicle comprises at least one drive for providing a drive torque for propelling the pedal-driven vehicle. The at least one drive may preferably be configured as an electric motor and/or positioned in a center motor assembly on the pedal-driven vehicle.

It may be provided in the context of the disclosure that at least one gearshift and/or control unit and/or detection unit and/or at least one drive comprises data processing device. The data processing device may comprise at least one processor and/or working memory and/or non-volatile data store.

At least one control unit may be brought into communication and/or signal communication with a user interface of the gear shift and/or detection unit and/or a drive, at least temporarily. Thus, data and/or control or regulating signals between the units may be exchanged.

At least one control unit and at least one detection unit may be configured as a common unit.

According to a fourth aspect, the present disclosure relates to a computer program product of the disclosure, comprising instructions which cause a gearshift according to the second aspect of the disclosure and/or a pedal-driven vehicle in accordance with the third aspect to execute a method in accordance with the first aspect. With respect to a computer program product according to the disclosure, the same advantages result in that they have already been described in relation to a method according to the disclosure and/or a gear shift according to the disclosure and/or a pedal-driven vehicle according to the disclosure.

According to a fifth aspect, the present disclosure relates to a computer-readable medium, in particular a storage medium, wherein a computer program product according to the fourth aspect of the disclosure is stored on the computer-readable medium. With respect to a computer-readable medium according to the disclosure, the same advantages result in that they have already been described in relation to a method according to the disclosure and/or a gearshift according to the disclosure and/or pedal-driven vehicle according to the disclosure and/or a computer program product according to the disclosure.

According to a sixth aspect, the present disclosure relates to a data carrier signal transmitting a computer program product according to the fourth aspect of the present disclosure. With respect to a data carrier signal according to the disclosure, the same advantages result in that they have already been described in relation to a method according to the disclosure and/or a gearshift according to the disclosure and/or a pedal-driven vehicle according to the disclosure and/or a computer program product according to the disclosure and/or a computer-readable medium according to the disclosure.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination.

The figures schematically show the following:

FIG. 1 is a view of a method, and

FIG. 2 is a view of a pedal-driven vehicle.

### DETAILED DESCRIPTION

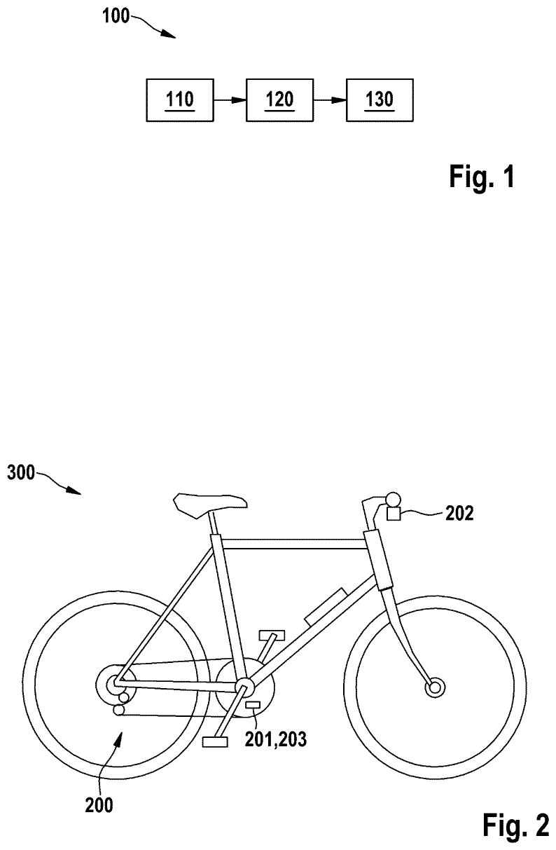

FIG. 1 shows a method 100 for operating a gearshift 200 for a pedal-driven vehicle 300 comprising a control unit 201, and at least one user interface 202 for manually triggering a shift operation:
receiving 110 a first shift instruction comprising an indication of origin, in particular by the control unit 201,
receiving 120 a second shift instruction comprising an indication of origin, in particular by the control unit 201, wherein the indication of origin of the first shift instruction is different from the indication of origin of the second shift instruction,
adjusting 130 the operation of the gearshift 200 as a function of the first and/or the second shift instruction.

FIG. 2 is a schematic view of a pedal-driven vehicle 300, comprising a gearshift 200. The gearshift 200 comprises a control unit 201, and at least one user interface 202 for manually triggering a shift operation. Preferably, the gearshift 200 is configured to be operated according to a method 100 shown in FIG. 1.

Further, the gearshift 200 illustrated in FIG. 2 includes a detection unit 203 for detecting at least one travel parameter of the pedal-driven vehicle 300, wherein the control unit 201 and the detection unit 203 are in the present case configured as a common unit.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for operating a gearshift for a pedal-driven vehicle that includes a control unit and at least one user interface for manually triggering a shift operation, the method comprising:
receiving a first shift instruction including an indication of origin by the control unit;
receiving a second shift instruction including an indication of origin by the control unit, wherein the indication of origin of the first shift instruction is different from the indication of origin of the second shift instruction; and
adjusting the operation of the gearshift as a function of the first shift instruction and/or the second shift instruction by the control unit.

2. The method according to claim 1, wherein the first shift instruction includes a target gear specification and the second shift instruction includes a target gear specification, wherein adjusting the operation of the gearshift comprises:
discarding the second shift instruction when the target gear specification of the second shift instruction matches the target gear specification of the first shift instruction.

3. The method according to claim 1, wherein adjusting the operation of the gearshift comprises:
discarding the second shift instruction when the second shift instruction has been received within a predetermined time interval upon receipt of the first shift instruction.

4. The method according to claim 1, further comprising detecting an implementation status of the first shift instruction, wherein:
the implementation status is characteristic of whether the first shift instruction has been implemented, and
adjusting the operation of the gearshift comprises discarding the first shift instruction when the implementation status is negative by the control unit.

5. The method according to claim 4, wherein the first shift instruction is discarded only if the indication of origin of the second shift instruction is characteristic of a manually triggered shift operation.

6. The method according to claim 1, further comprising detecting an implementation status of the first shift command, wherein:
the implementation status is characteristic of whether the first shift command has been implemented, and
adjusting the operation of the gearshift comprises providing a third shift instruction, wherein the third shift instruction is configured inversely to the first shift instruction when the implementation status is positive by the control unit.

7. The method according to claim 1, wherein adjusting the operation of the gearshift comprises:
blocking a reception of further shift instructions with an indication of origin characteristic of an automatically triggered shift operation, for a predetermined time interval upon receipt of a shift instruction, the indication of origin of which is characteristic of an automatically triggered shift operation.

8. The method according to claim 1, further comprising detecting at least one travel parameter by a detection unit, wherein adjusting the operation of the gearshift comprises:
blocking a reception of further shift instructions with an indication of origin characteristic of an automatically triggered shift operation upon receipt of a shift instruction, the indication of origin of which is characteristic of an automatically triggered shift operation, until a rate of change over time of the at least one travel parameter reaches or exceeds a predetermined limit value.

9. The method according to claim 8, wherein the at least one travel parameter is configured as one of the following:
a speed of the pedal-driven vehicle,
a rider pedaling frequency,
a rider torque, and
a rider power.

10. A gearshift for a pedal-driven vehicle, comprising:
a control unit; and
at least one user interface configured to manually trigger a shift operation,
wherein the gearshift is configured to be operated according to the method of claim 1.

11. A pedal-driven vehicle comprising at least one gearshift according to claim 10.

12. A computer program product comprising instructions that cause a gearshift to perform the method according to claim 1.

13. A computer-readable medium on which the computer program product according to claim 12 is stored.

14. A data carrier signal transmitting the computer program product according to claim 12.

15. The method according to claim 1, wherein adjusting the operation of the gearshift comprises:
discarding the second shift instruction when the second shift instruction has been received within a predetermined time interval upon receipt of the first shift instruction, if the indication of the origin of the second shift instruction is characteristic of an automatically triggered shift operation.
